(19) United States
(12) Patent Application Publication
(10) Pub. No.: US 2026/0065319 A1
(43) Pub. Date: Mar. 5, 2026

(54) SYSTEMS AND METHODS FOR MONITORING PRODUCT FEATURE USAGE TO RECOMMEND INSTRUCTIONS

(71) Applicant: Adeia Guides Inc., San Jose, CA (US)

(72) Inventors: Mona Singh, Cary, NC (US); Reda Harb, Saint Petersburg, FL (US)

(21) Appl. No.: 19/381,266

(22) Filed: Nov. 6, 2025

Related U.S. Application Data
(63) Continuation of application No. 18/532,528, filed on Dec. 7, 2023.

(51) Int. Cl. G06Q 30/0251; G06Q 30/0601

(52) U.S. Cl. CPC G06Q 30/0253; G06Q 30/0623

(57) ABSTRACT

Systems and methods are presented herein for post-sale and no-sale feature advertisements that improve customer satisfaction and customer retention. At least one feature advertisement is identified that corresponds to one or more product features of a new model of a product purchased by the purchaser. At least one teaser advertisement is identified that corresponds to one or more other product features of the new model. A data structure corresponding to an associated viewer, based on a relationship characterized by communication between the purchaser and the associated viewer, is identified using one or more of an advertisement server or an eCommerce platform. The at least one feature advertisement based on a first product feature of the new model is presented to the purchaser. The at least one teaser advertisement based on a second product feature is displayed via a device of the associated user.

### CROSS-REFERENCE TO RELATED APPLICATION

This application is a continuation of U.S. patent application Ser. No. 18/532,528, filed Dec. 7, 2023, which is hereby incorporated by reference herein in its entirety.

### INTRODUCTION

The present disclosure is directed to systems and methods for generating or providing advertisements of products to improve customer satisfaction and retention, and more particularly, to systems and methods that generate or provide advertisements directed to features of a product that a user has already purchased or that a user may consider purchasing based on use patterns of the user with respect to other products related to the product or lack of use of the product as characterized by the user interaction data or use patterns associated with the product.

### SUMMARY

Targeting individuals that previously purchased a product for providing advertisements of newer models of the product is an advertising strategy that lacks specificity with respect to exposing individuals to details of product features. For example, a user of a shopping interface may have interacted with an advertisement for a new model electric toothbrush and subsequent advertisements may be presented to the user that indicate a change in price of the new model electric toothbrush without providing indications of whether features of the new model electric toothbrush provide improvements for the user over a currently owned (e.g., previously purchased) electric toothbrush of the user. Additionally, some current advertisement targeting strategies may indicate how a newer product is better than other products on the market being released for purchase in a similar time period. However, these strategies are also deficient in that these targeted advertisement strategies fail to consider other products a user has purchased that may be related to the product of the targeted advertisement and, if presented in an enticing manner, may cause the user to make a new purchase such that the user has an inventory of compatible products. An advertisement strategy that is focused on features of currently owned products and usage data of current products is needed to cultivate an immersive and personalized advertisement experience for a user to improve post-sale satisfaction of the customer and retain the customer as a repeat purchaser of products.

Customer intent determination algorithms, or other user or purchaser characterization means, have been utilized in some current targeted advertising strategies. For example, an advertisement selection algorithm might determine that a user might want to buy the newer model based on an indication that a user purchased an older model within a certain time period (e.g., within a duration of a product warranty such as two years). A video advertisement may be generated and presented indicative of the amount of time that has passed since the user last purchased or replaced a particular product. Similarly, the video advertisement may be presented to the user based at least in part on a sale associated with the product or tracking of a price of the product that indicates a sudden reduction in price and this approach is also not product feature-based.

Advertisers may prefer to present different versions of an advertisement based on whether the user has purchased the item in the past or has not purchased the item. For example, a product vendor, supplier, or manufacturer may target a person who already purchased the product before and may generate a video advertisement that is focused on the new features that are not part of the model that the purchaser already owns such that the feature or features are highlighted. Continuing this example, the new feature advertisement would be different to what gets presented to someone who is on the market for the product, but has not purchased a version of the product before or does not currently own a related or similar product. By incorporating a feature-based approach to generating advertisements for cascading to potential or current customers, the viewers of each version of the feature-based advertisements are exposed to aspects of products and potential uses that the viewer may not have known about or previously considered desirable. These feature-based advertisements may also be constructed in a manner to highlight an advertised product's association or compatibility with other products the viewer may own or have access to (e.g., where members of the user's social circle have presented the product, and the viewer is considering becoming a purchaser). For example, an advertised toothbrush might be compatible with a personal device (e.g., a smart phone) that the user owns (e.g., such that the smart phone tracks use patterns of the toothbrush and generate reminders for maintaining a routine).

Continuing the toothbrush example, an advertiser of the toothbrush may generate and provide a bumper advertisement (e.g., a short video to introduce an audience to product, concept, or message that is intended to entice the viewers or audience to further investigate purchase options) that can be combined with one or more additional full length video advertisements. For example, a bumper advertisement may be presented. Bumper advertisements may be considered video advertisements that are intended to expand reach of a product to additional customers with a particular focus on a brand of the product. The product may have a primary, or general, advertisement along with one or more bumper advertisements focused on a specific feature. These one or more bumper advertisements may be reduced in duration for presenting focused information (e.g., about a specific feature) and these bumper advertisements may be presented as auxiliary advertisements after the primary, or general, advertisement has be viewed (e.g., by a purchaser or an associated viewer).

Each of the additional full length video advertisements may, for example, communicate details to the viewers about the different features that the advertiser wants to highlight to the potential consumer. For example, one of the full length video advertisements may provide details about a special sensor that can detect build-up around teeth while a second of the full length video advertisements may provide details about different operating modes of the toothbrush (e.g., a whitening operating mode, a gum massaging operating more, or a plaque removal operating mode). Where the advertiser utilizes an advertisement server as part of the advertisement placement strategy, a bumper advertisement, once played, may be configured to transmit a request or call to the advertisement server. The request or call may incorporate past purchase information to allow the advertisement server to select elements to present to consumers as the advertiser coordinates the generation and dispersion of targeted advertisements.

Videos that an advertiser generates may incorporate tags (e.g., metadata stored in a data structure which can be processed for selective advertisement insertion). These tags may preferably communicate whether an advertisement is generic (e.g., for distribution throughout a targeted population) or customized (e.g., for presentation to particular targeted potential consumers or repeat consumers). For example, the generic video advertisement is presented to consumers that have provided indications they have an interest in electric toothbrushes without having indications of a brand preference whereas the customized video advertisement is presented to consumers that already own an older version of a toothbrush and includes advanced features associated with the toothbrush (e.g., newer or improved features or services enabled by the newer version of the toothbrush).

Advertisers may assume that a product owner is already familiar with the benefits of their currently owner product and, therefore, the tags may be utilized to prevent exposing a target population to advertisements that do not provide information to entice a future purchase (e.g., the generic versions of the advertisement). As a result, advertisers may prefer to have the customized video advertisements communicate which features of a newer model are not available via an older model (e.g., via one or more of a graphic overlay highlighting differences or an interactive overlay which provides a means for examining particular features in detail, including a way to find an interface for purchasing the newer model). According to this example of advertising, an advertisement server is configured to generate and provide customized advertisements (e.g., incorporating additional features or focused on differences between products) so as to provide a means to pick video advertisements to present based on a user's personal preferences as defined by user activity with product information, a user purchase history, or a user set of use patterns with a particular product. For example, an application programming interface may result in the transmission of an API call or API request based on flags associated with user login credentials, user activity, or product attributes (e.g., make and model of the product). The advertiser may prefer to utilize different video advertisements (e.g., combinations of generic and customized advertisements) based on advertisement campaign parameters and other consumer outreach criteria (e.g., based on feedback from users who actively block or provide comments on previously cascaded advertisements).

Responsive to the identified deficiencies in known targeted advertising practices, the disclosure is directed to systems and methods for generating or providing advertisements directed to features of a product that a user has already purchased or that a user may consider purchasing based on use patterns of the user with respect to other products related to the product or lack of use of the product as characterized by the user patterns. The method by which the advertisements are provided is irrelevant for the purposes of this disclosure. For example, one or more of server-side advertisement insertion, client-side advertisement insertion, server-guided advertisement insertion may be utilized in combination with one or more of real-time bidding or general advertising campaigns. In some embodiments, the disclosure is directed to a method comprising identifying a purchase history of products corresponding to a user device. At a server, a determination is made that a product has previously been purchased based on the purchase history. Production information corresponding to the product is retrieved from the server. At least one replacement product is identified via the server to advertise based on the product information. The at least one replacement product aligns with at least one element of the purchase history and comprises at least one product feature that is determined to be inconsistent with use patterns of the product. An advertisement is presented for display at one or more of the user device or a secondary user device communicatively accessible via the user device based on the at least one replacement product.

In some embodiments, the disclosure is directed to a method for presenting a feature advertisement to a purchaser and at least one teaser advertisement to an associated viewer, wherein the associated viewer is affiliated with the purchaser based at least on a communication history between the associated viewer and the purchaser. The method includes retrieving, using processing circuitry, at least one feature advertisement from one or more servers, wherein the at least one feature advertisement corresponds to one or more product features of a new model of a product purchased by the purchaser and the at least one feature advertisement is directed to a first group of product features. Using the processing circuitry, at least one teaser advertisement from the one or more servers is retrieved, wherein the at least one teaser advertisement corresponds to one or more other product features of the new model and the at least one teaser advertisement is directed to a second group of product features. Using one or more of an advertisement server or an eCommerce platform, a data structure corresponding to the associated viewer based on a relationship between the purchaser and the associated viewer (e.g., as characterized by one or more of communication paths between a device of the purchaser and a device of the associated viewer, social media interactions or connections, communication history between affiliated devices or application profiles, or verbal exchanges stored via voice recognition) is identified. A first product feature of the first group of product features, and a second product feature, of the second group of product features, are identified using the processing circuitry. Using a device of the purchaser, the at least one feature advertisement based on the first product feature is displayed (e.g., to the purchaser). Using a device of the associated viewer, the at least one teaser advertisement based on the second product feature is displayed (e.g., to the associated viewer). In some embodiments, the data structure comprises criteria of the associated viewer indicative of the associated viewer being outside a target advertising pool of at least one advertiser.

In some embodiments, the method comprises receiving one or more of a query or a prompt corresponding to a request for a list of products via a device of the purchaser. A relevant purchase history is identified based on one or more of the query or the prompt. The relevant purchase history is compared to the list of products. Based on the comparing, a determination is made that at least one product of the list of products has previously been purchased. The one or more product features are identified from a data structure corresponding to the at least one product. Additionally, or alternatively, the prompt is generated by an artificial intelligence generative engine based on one or more elements of the query. The prompt may cause processing circuitry to retrieve the list of products based on one or more of a connection status or connection strength between one or more communicatively accessible servers and the user device.

In some embodiments, the relevant purchase history may be identified based on one or more functions associated with the at least one product. Additionally, or alternatively, the relevant purchase history is identified based on information acquired from one or more of advertisements or product reviews associated with the at least one product. The one or more product features may comprise one or more of features or uses of a product that are modified via at least one replacement product. In some embodiments, the one or more product features are identified based on processing of one or more of verbal exchanges or written exchanges accessible via one or more of the device of the purchaser or the device of the associated viewer. The verbal exchanges or the written exchanges comprise one or more indications of a desire for an improvement of a product comprising the one or more product features.

In some embodiments, the method comprises identifying at least one product comprising the one or more product features that was purchased by the purchaser. A data structure is retrieved from a product usage server, and the data structure is comprised of the data stored in memory that is indicative of one or more use patterns of the at least one product. Based on the one or more use patterns, the at least one product is determined to correspond to a probability score that indicates the user will either replace the product or dispose of the product. An updated probability score is computed based on interaction of the associated viewer with one or more of the first teaser advertisement or the second teaser advertisement. The updated probability score is compared to the probability score. In response to determining the updated probability score exceeds the probability score, at least one data structure corresponding to rendering criteria for one or more of the first teaser advertisement or the second teaser advertisement is retrieved.

In some embodiments, the one or more use patterns are characterized by the data stored in memory. The data stored in memory, when processed by the processing circuitry, comprises indications of the one or more product features being unused or the one or more product features being inefficiently used. The data stored in memory may be comprised of information indicative of one or more use patterns of the at least one product is generated based on one or more of user interaction data associated with a device interface of the at least one product, data generated from one or more of videos or pictures of the purchaser interacting with the at least one product, or indications of use of the at least one product generated from processing of one or more of verbal exchanges or exchanges of strings of characters between the purchaser and the associated viewer, wherein the one or more verbal exchanges or exchanges of strings of characters comprise at least one mention of the at least one product.

In some embodiments, the disclosure is directed to a system comprising a server communicatively coupled to processing circuitry of a user device, wherein the server is configured to perform at least one of accessing product information, accessing products to recommend for purchasing, or generating advertisements based on product information. The system also comprises processing circuitry configured to executed instructions corresponding to the one or more methods of this disclosure. A non-transitory computer-readable medium having non-transitory computer-readable instructions encoded thereon that, when executed by one or more of processing circuitry or control circuitry, cause circuitry to perform one or more elements of the one or more methods of this disclosure.

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1A illustrates an advertising scenario where an associate of a purchaser is presented an advertisement corresponding to features of a product a purchaser used and an advertisement corresponding to features of a product that the purchaser has not used, in accordance with some embodiments of the disclosure;

FIG. 1B illustrates a flow of information across multiple devices in order to present a purchaser and an associate of the purchaser with advertisements related to different features of a product that the purchaser has use data for, in accordance with some embodiments of the disclosure;

FIG. 2A is a representative system capable of executing the methods of this disclosure; in accordance with some embodiments of the disclosure;

FIG. 2B is a representative device configured to be integrated into the system of FIG. 2A for executing the methods of this disclosure, in accordance with some embodiments of the disclosure;

FIG. 3 is a block diagram representing an illustrative process for presenting feature advertisements of a product to an associate of a purchaser of the product, in accordance with some embodiments of the disclosure;

FIG. 4 is a block diagram representing an illustrative process for identifying product features to present in one or more advertisements, in accordance with some embodiments of the disclosure; and

FIG. 5 is a block diagram representing an illustrative process for presenting feature advertisements of a product to an associate of a purchaser of the product, in accordance with some embodiments of the disclosure.

### DETAILED DESCRIPTION

Methods and systems are provided herein for systems and methods that generate or provide advertisements directed to features of a product that a user has already purchased or that a user may consider purchasing based on use patterns of the user with respect to other products related to the product or lack of use of the product as characterized by the user interaction data or use patterns with the product.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (RAM), etc.

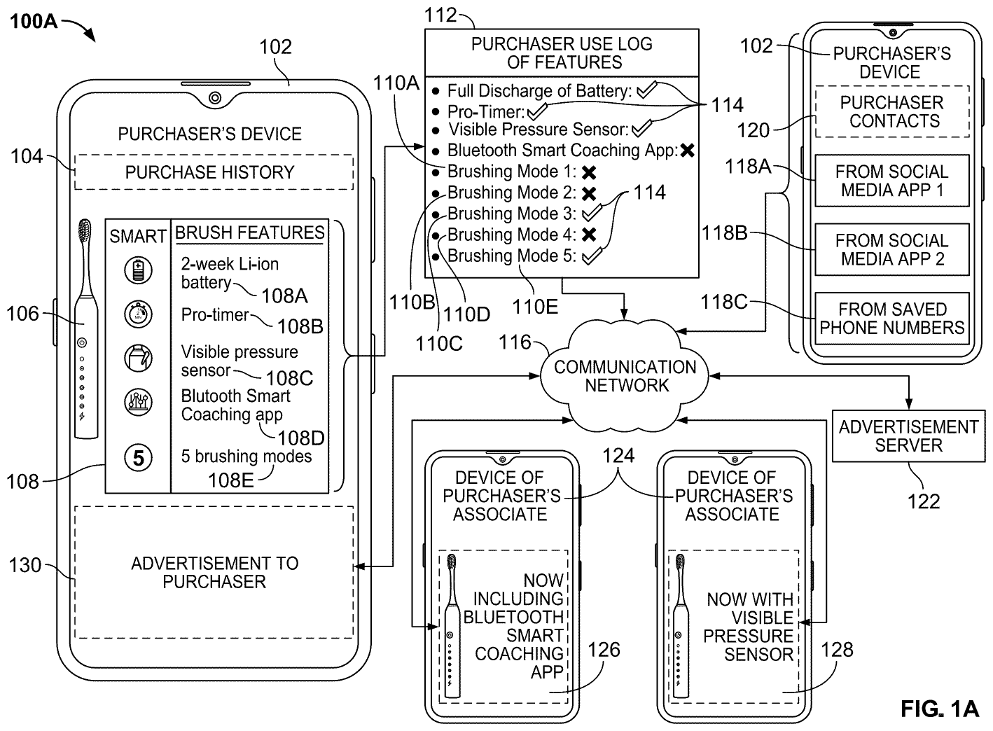

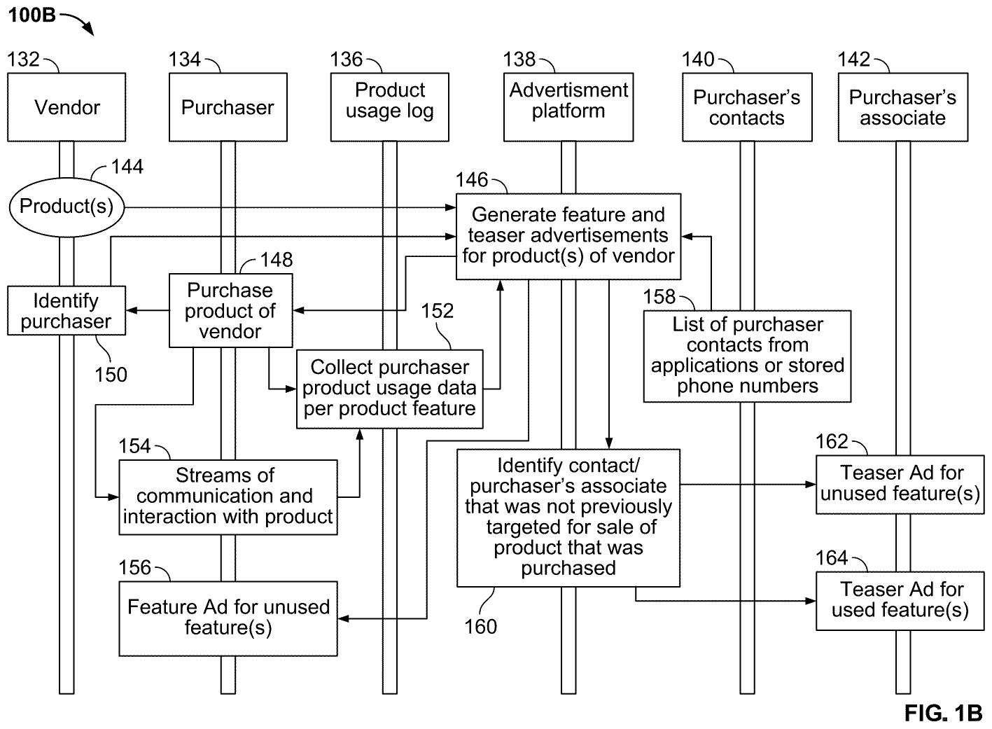

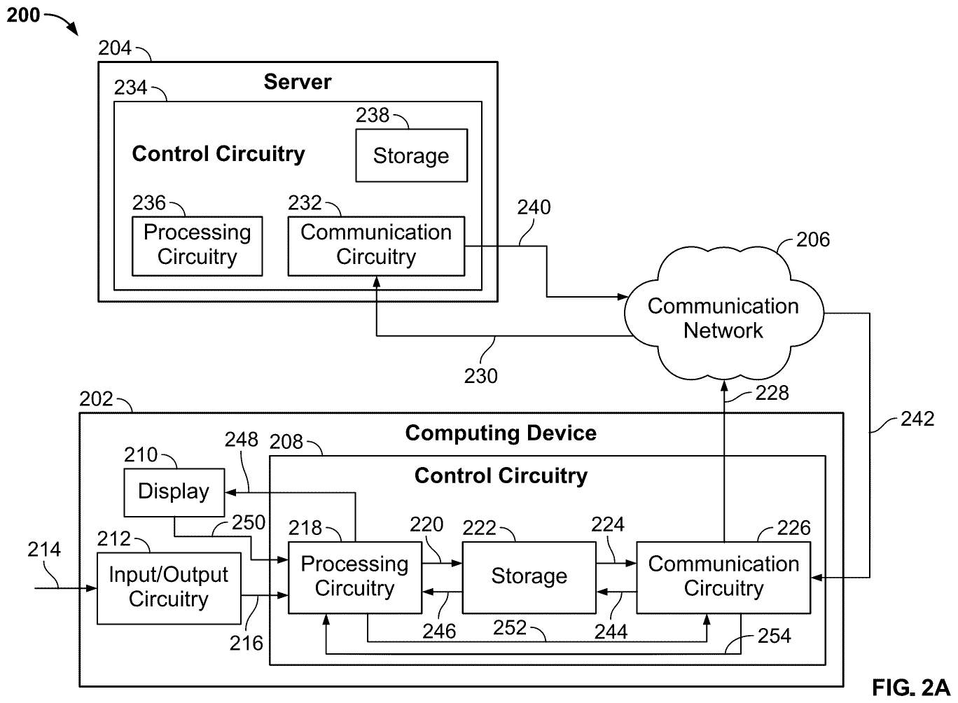

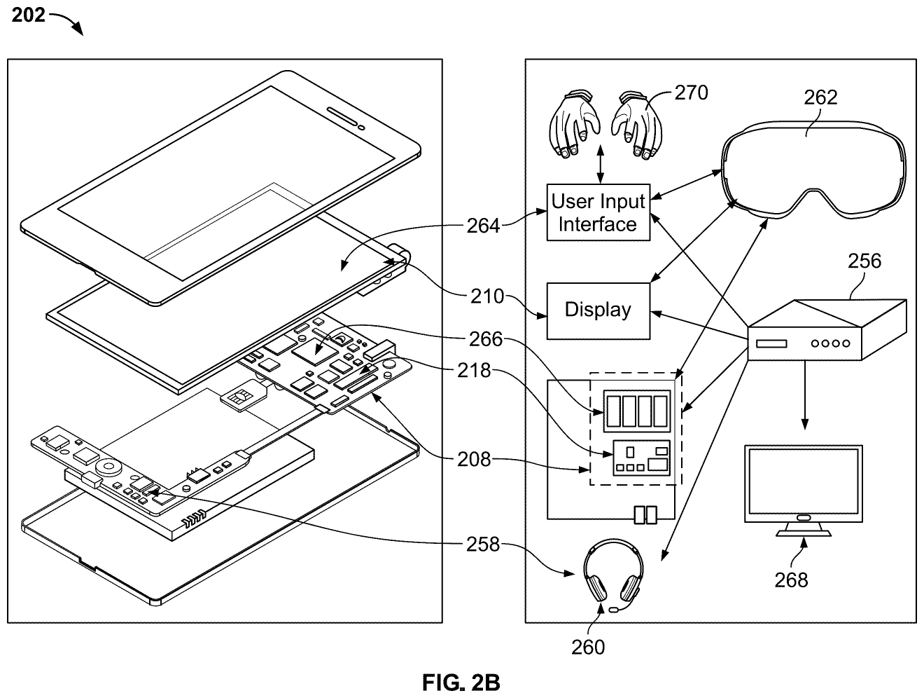

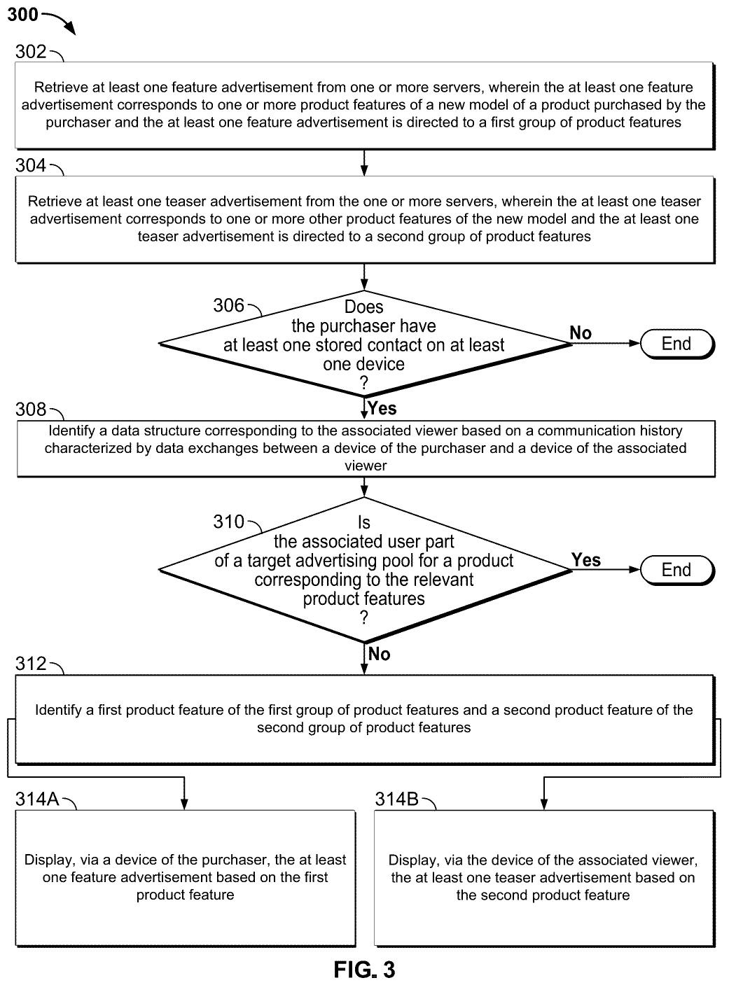

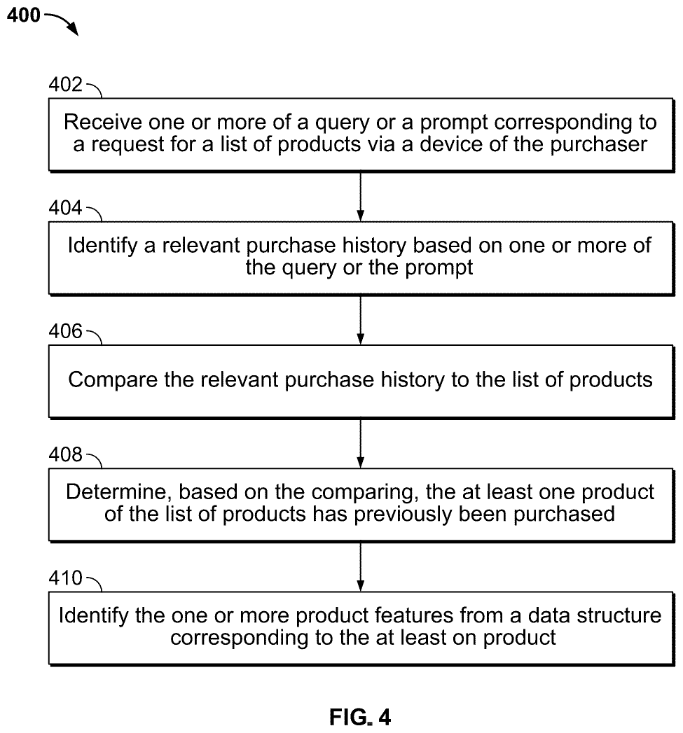

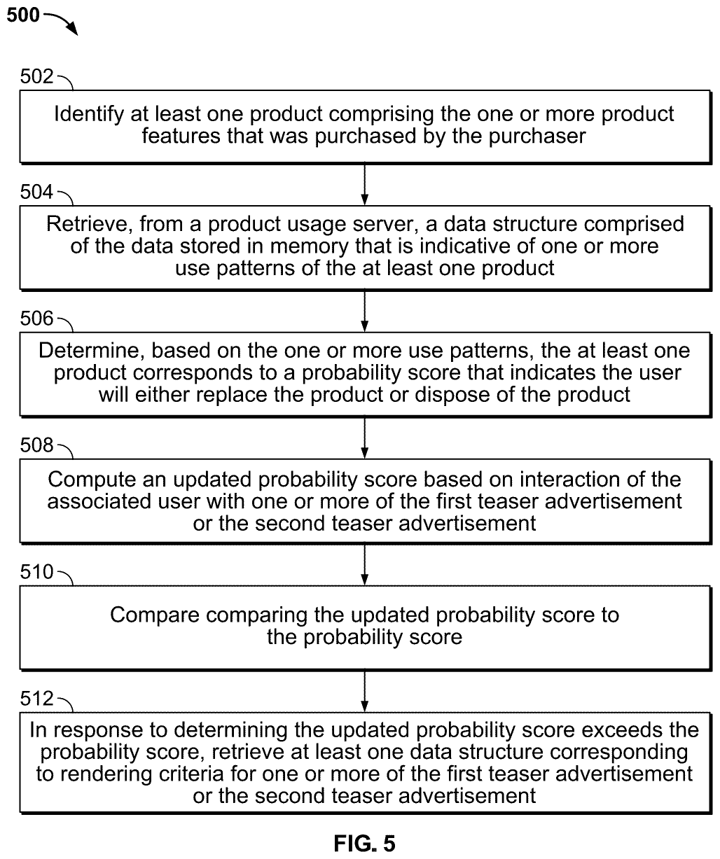

FIG. 1A depicts advertising scenario 100A, where an associate of a purchaser is presented an advertisement corresponding to features of a product a purchaser used and an advertisement corresponding to features of a product that the purchaser has not used, in accordance with some embodiments of the disclosure. Advertising scenario 100A may include the information flow depicted by FIG. 1B and may be executed, in whole or in part, using one or more of the elements of the system of FIG. 2A or the device of FIG. 2B. Advertising scenario 100A may be enabled by execution of one or more elements of process 300 of FIG. 3, process 400 of FIG. 4, or process 500 of FIG. 5 (e.g., by use of one or more elements of the system of FIG. 2A or the device of FIG. 2B).

Advertising scenario 100A has utility for one or more of eCommerce or automatic configuration of advertisements or search results. For example, an eCommerce interface may already track whether a particular product has been purchased or not. The interface may also track one or more of a type of advertisement or a number of advertisements presented to a purchaser of a product before the purchase was made. Additionally, the interface may provide a list indicative of when the purchase of a particular product was made and, more particularly, may provide an indication on the product's advertising or listing page when the product was last purchased by the purchaser as well as whether a newer model of the product is available. The issue with this know approach is that each user of the eCommerce interface is presented a same set of information (e.g., one or more of images, videos, comments, or reviews) with respect to the product being listed for sale without regard for whether the product was purchased before by a particular user (e.g., the purchaser). Advertising scenario 100A depicts a product being advertised to an associate of a purchaser of the product based on the purchaser's use patterns. Additionally, or alternatively, a new model of the product may be the subject of the advertisements presented to the associate. In some embodiments, one or more advertisements may also be presented to the purchaser. For example, where the purchaser continuously searches for instructions on how to make a particular feature of a purchased product function, advertisements to the purchaser of the new model may be directed to features of the new model that resolve the need for repeated queries of using a particular feature. Accordingly, a smart home assistant is no longer needed to differentiate between advertisements for a previous purchaser and an associate of the purchaser when determining content of advertisements to display to previous purchasers as compared to potential purchasers who may not be part of existing advertisement campaigns.

Advertising scenario 100A, and the various embodiments of this disclosure, include definitions of various elements. A feature advertisement in the context of this disclosure is an advertisement that provides detailed information on one or a few specific features of a product or service (e.g., how to activate the feature, its benefits, and any disclaimers). A brand advertisement in the context of this disclosure is an advertisement that provides high-level information on a product or service to establish its brand (e.g., one or more of an indication of market favorability, market relevancy, or demographics of purchasers or users of particular features of a purchased product). A teaser advertisement in the context of this disclosure is a subclass of brand advertisements that is restricted to one or a few features of a product or service (e.g., the benefit of a particular feature, or popularity thereof, but without details of operation of the feature with respect to the product). Teaser advertisements may be reduced in length, size, or information communicated to potential consumers than a full brand advertisement. In this disclosure, where a teaser advertisement is referenced, the teaser advertisement may, in some embodiments, be substituted with a feature advertisement or a brand advertisement. In some embodiments, the opposite replacement applies as well.

As shown in FIG. 1A, purchaser's device 102 includes access to purchase history 104. Purchase history 104 includes product icon 106 and product feature list 108. Product feature list 108 may be based on an advertisement that caused the purchaser to purchase the product of product icon 106 or may be based on a current listing or advertisement for the product. Referring to product icon 106, the product may be a smart toothbrush. Product feature list 108 includes features 108A-E, where feature 108E includes modes 110A-E. Where the product is a smart product configured to be paired with purchaser's device 102, for example, purchaser use log of features 112, which stores data indicative of one or more of types of use (e.g., proper or improper), number or frequency of use (e.g., a scalar value or a number of times over a set time period), or whether use has ever be recorded for each of features 108A-E. Purchaser use log of features 112 may be stored via one or more of purchaser's device 102, communication network 114, or advertisement server 116.

Purchaser use log of features 112, as shown in FIG. 1A, depicts a series of flags indicating whether or not each features from product feature list 108 has been used by the purchaser. For example, features A-C each have flag 114, which indicates use of a respective feature by the purchaser where feature D and three of modes 110A-E of feature 108E are without a flag indicating use (e.g., as represented by the black “x” indicating a lack of flag or use data for generating the flag). Using communication network 116, advertisement server 122 receives one or more of flags 114 of purchaser use log of features 112, in whole or in part, to begin developing a future cascade of advertisements. Additionally, purchaser's device 102 is also checked for purchaser contacts 120 (e.g., automatically or based on a prompt and device privacy settings as enabled by one or more of the eCommerce interface on which the purchase was made or other data accessibility settings affiliated with purchaser's device 102). Purchaser contacts 120 includes contact lists 118A-C, which each correspond to one or more of a social media application contact list or a saved phone number contact list. At least one contact from purchaser contacts 120 is identified as an associate of the purchaser. The associate of the purchaser is determined not be part of a targeted advertisement campaign for the product of product icon 106. Additionally, or alternatively, the associate may also be identified as not being part of a targeted advertisement campaign for a newer model of the product of product icon 106. The targeted advertisement campaign may comprise one or more elements indicating the scope of the advertisement campaign accessible via advertisement server 122.

In some embodiments, advertisement server 122 may prioritize one or more advertisement materials on multiple levels. For example, prioritization may be based on purchaser or associate demographics as well as an amount of time that has passed since the purchaser originally bought the product or an amount of conversation with respect to one or more features of the purchased product between the associate and the purchaser. Where a particular element of an advertising campaign is prioritized and corresponds to a particular feature (e.g., younger demographics may be inclined to use or purchase devices with Bluetooth coaching applications), then display of the higher priority features is either more frequent or prioritized over other features (e.g., features 108D is presented more often than feature 108E or modes 110A-E). In some embodiments, advertisement server 122 may prioritize features a particular vendor wishes to highlight or push based on market data related to preferences of target consumers for particular features (e.g., popularity ratings based on comments, discussions or product ratings provided via product reviews). Additionally, or alternatively, the priority for each feature to be shown via advertising may be based on utility, whether alone or with other data, such that the primary function of the device is readily accessible (e.g., the smart toothbrush provides a timer and a pressure sensor to improve duration of brushing without expecting damage to teeth of a user as the user reduces a brushing load when the visible pressure sensor generates a light).

In response to the associate of the purchaser being identified via purchaser contacts 120, device of purchaser's associate 124 is identified for receiving advertisement data from advertisement server 122 (e.g., via communication network 116). Advertisement server 122 may generate, or retrieve, one or more of teaser advertisement 126 or teaser advertisement 128 for display on device of purchaser's associate 124, based on purchaser use log of features 112 corresponding to use data of the purchaser with respect to one or more of features 108A-E. Teaser advertisement 126 displays a teaser advertisement based on feature 108D, the blue tooth smart coaching application, which lacks any data indicating use by the purchaser. Teaser advertisement 126 is directed to retaining the original customer (e.g., the purchaser) based on discussions between the purchaser's associate and the purchaser by reintroducing the unused feature into conversations while also providing an opportunity to gain a new customer (e.g., the associate). Teaser advertisement 128 displays a teaser advertisement based on feature 108C, which has flag 114 raised, indicating use by the purchaser. Teaser advertisement 128 may be utilized by the associate to refresh the purchaser on features previously known to the purchaser, but not recently used, for example. Additionally, or alternatively, teaser advertisement 128 may be utilized to attract the associate as a new customer (e.g., as teaser advertisement 128 may be displayed based on communication streams between the purchaser and the associate via associated devices for each user that indicate the associate has interest in a particular feature). Teaser advertisements 126 and 128 may be displayed separately or contemporaneously across different interfaces of device of purchaser's associate 124, depending on one or more advertisement campaign parameter settings defined via advertisement server 122 or settings of device of purchaser's associate 124.

In some embodiments, as shown in FIG. 1A, advertisement 130 may also be presented via purchaser's device (e.g., on purchase history 104 or another eCommerce related interface). Advertisement 130 may be transmitted via communication network 116 from advertisement server 122 based on purchaser use log of features 112 or indications that a newer replacement product that supersedes the functions or applicability to the purchaser of the product represented via product icon 106. For example, where purchaser use log of features 112 indicates a user only utilized one of features 108A-E, or only utilized a particular feature once, a newer or more focused model of a product corresponding to the product represented by product icon 106 may be presented to the user via advertisement 130. In some embodiments, this version of advertisement 130 may only be presented based on advertisement campaign parameters of advertisement server 122, which may limit presentation of different or newer models of products to previous purchasers until a warranty period has expired (e.g., more than 6 months from the purchase). In some embodiments, advertisement 130 may correspond to purchaser use log of features 112 in that advertisement 130 may be generated via advertisement server 122 based on one or more of features 108A-E being without a use flag in purchaser use log of features 112. For example, as the purchaser has not used feature 108C (e.g., the blue tooth smart coaching application), and the associate of the purchaser has received a teaser add directed to feature 108C resulting in conversation, then advertisement 130 may be generated to promote or remind the purchaser that the currently owner product still has features 108C. In this example, the teaser advertisement for the original purchaser may only be queued for display on purchaser's device 102 if either the purchase was made within the warranty period (e.g., within the last 6 months) or communications from the purchaser to the associate, or other associates, indicates the purchaser intends to discard the product.

An advantage of advertising scenario 100A is that advertisement server 122 may have teaser advertisements prepared based on an original product listing on an eCommerce platform, for example, directed to each feature of features 108A-E. As a result, these teaser advertisements incorporate focused information to more directly tailor product information presented to the purchaser and related associates. The order in which the teaser advertisements are presented may be based, for example, on the data from purchaser use log of features 112. Additionally, or alternatively, the cascading of these product feature focused advertisements provides an advantage in existing purchaser retainment as well as branching out via a new stream of communication to new potential purchasers who may also reinforce to the original purchaser that the product has utility. In some embodiments, comments on product listings (e.g., via eCommerce interfaces) or comments on advertisements on social media platforms may also be used to score or rank features of the product to create a priority in terms of which of the teaser advertisements to display and in which order (e.g., to the purchaser or one or more associates of the purchaser). For example, a lack of comments on a feature may yield a score of zero and no teaser advertisements are cascaded. Conversely, a feature with more comments than another feature will gain priority in terms of the feature with more comments being cascaded to one or more devices as a teaser advertisement. Content of the comments (e.g., positive comments on features and negative comments on features), may also be considered in terms of identifying which features to cascade respective teaser advertisements for. For example, a feature with negative comments may not be presented as part of a teaser advertisement to the user.

In some embodiments, advertising scenario 100A may be used to populate advertisement spaces in a personalized fashion on different consumer devices (e.g., purchaser's device 102 is presented with different search results and corresponding advertisements than the device of a purchaser's associate 124). For example, end user devices (e.g., smart devices or smart phones) may have settings that provide a search engine access to purchased items or a subset of purchased items. For example, a purchased item may be an oven. A purchaser may repeatedly search for how to access or operate particular features of the oven. Based on the level of repetition of these searches or the content of these searches, an intent determination engine may be utilized to determine of the purchaser may benefit from a new model of the product with, for example, more intuitive features. Therefore, it would be beneficial to the consumer if certain aspects of the new model were highlighted for the purchaser on a page where an advertisement for the new model would be displayed. Additionally, or alternatively, the advertisement configuration may trigger highlighting or emphasis of certain elements of the new model's purchase page such that the purchaser of the old model can easily track elements the purchaser is interested in upgrading by purchasing the new model. For example, the order of demonstration videos, or related product videos, may be modified based on a purchase history or queries related to a purchase history. With respect to the oven example, if a purchaser continuously asks how to set a timer of the oven, the purchaser may be presented videos of a simple voice activated timer in a newer model. Similarly, the comments related to the new model and the simple voice activated timer may be emphasized to entice the purchase to make a new purchase. The purchase page may be a website dedicated to the vendor, seller or manufacturer. Similarly, the purchase page maybe accessible through an electronic commerce (eCommerce) service.

Where a search engine is communicatively coupled to an email account, the various services may utilize the data shared therebetween to incorporate or exclude a particular device, and by extension, the user, from particular advertisement campaigns. Additionally, or alternatively, a search engine may be provided access to eCommerce account data in order to enhance or personalize returned search results (e.g., in response to prompts for products or queries for products). Such authorization for data exchange or data access would allow the search engine to use such information to recommend a device owned by the user to perform an action or present a user manual with instructions (e.g., providing a purchaser an advertisement that highlights an unused feature that otherwise would be useful to the user). Referring back to the smart toothbrush example, a user may search for indications of how much pressure is too much for brushing teeth and one or more of a feature advertisement or a teaser advertisement may be presented with respective elements corresponding to feature 108C (e.g., a visible pressure sensor that lights up when pressure applied via the toothbrush exceeds a recommended threshold). Additionally, or alternatively, viewing history of videos (e.g., videos related to one or more activities that could be assisted by one or more of features 108A-E) or shows (e.g., personal health or hygiene shows that have metadata triggering advertisement insertion of particular products) may result in one or more teaser advertisements being generated as overlays or inserted into predefined advertisement spaces related to one or more of features 108A-E.

In some embodiments, advertising scenario 100A may be activated based on a search that is not text-based and may not need to involve actively viewing, or accessing by the user, purchase history 104. A virtual assistant communicatively coupled to communication network 116 may also be used to generate search or prompt criteria, which then gets transmitted to advertisement server 122 for presenting one or more advertisements to the purchaser or an associate of the purchaser (e.g., based on conversations between the purchaser and members of the purchaser's contact list in person or via previous communication between the users). A communication may be text-based (emails, text messages, user commenting on a social media post that was posted by either one), phone calls, video calls, being part of the same social network circle (i.e., connected on social network), etc. In some embodiments, an Internet of Things (e.g., IoT) platform may be accessed by one or more communicatively coupled devices affiliated with one or more of the purchaser, the associate of the purchaser, or respective devices therebetween. The IoT platform may include access to remote upgrades of interface, product listing, advertisements, or product purchaser statuses as well as product feature use tracking. As a result, prompts and queries presented to or generated via the IoT platform may also be used to identify user satisfaction or dissatisfaction with one or more product features, in the same way search engine queries may also be used as previously mentioned. Accordingly, one or more intent deriving engines, or the like, as affiliated with a particular device, personal assistant, interface, or other element of the IoT platform, may be utilized to derive intent behind one or more prompts, searches, or queries (e.g., including discussions between the purchaser and an associate, whether in person or characterized by data exchanges between devices by application based text or voice to text exchanges).

Other techniques are contemplated such as authorizing a search engine to access the purchased history associated with a user's eCommerce account (e.g., through Amazon or other platforms). This can be used to enhance a search for products to display to the purchaser (e.g., more specifically identified new models that resolve issues particular to the purchaser). For example, this would allow the search engine to use such information to recommend a device owned by the user to perform an action (e.g., set a timer on an oven that is part of a stove or range that is communicatively coupled to a personal smart device or a smart home assistant,) or present informational materials with instructions (e.g., manuals, help videos, etc.) if applicable, in response to queries related to a particular model of a product in the purchase history. The purchaser may, for example, repeatedly search for instructions on changing a clock on a stove or restricting data usage by an application on a personal end user device during specific time ranges (e.g., preferred sleeping time). The search engine could suggest how to perform such actions based on the devices that are owned by the user (e.g., communicatively coupled personal devices or home assistants with intent interpretation abilities) without the query even referencing the make or model of the device or devices. The content of a purchaser's viewing history may also be utilized by the search engine. For example, a purchaser may watch cooking shows repeatedly and an intent engine may be configured to identify one or more items used in the shows to assist the purchaser in future meal preparation. Accordingly, overlays and advertisements related to pertinent products may be generated for display such that the purchaser is directed to useful products to reduce repeated queries. Search is not limited to text-based, and the search can take place through a virtual assistant. By giving an intent module access to purchase history data, the user is able to retrieve information about the purchased product without the need to remember or recite the make and model of the product. When a user issues a query, such as spoken query, to the voice assistant, then the query is supplemented by the purchase history, during the query processing phase (e.g., after the voice query is converted to text, and the text is parsed to determine or identify the user or the query's intent, i.e., during the parsing phase and named entity recognition phase). The named entity maybe inferenced in such case, since if the user's query references an oven, then then named entity is the make/model of the oven or range that is part of the user's purchase history). In one embodiment, where multiple products of the same type are found in the user's purchase history, then the product associated with the latest purchase date is selected. In another embodiments, the voice assistant may prompt the user by asking the user to select one of the products found in the user's purchase history. Automatically supplementing a user's query with product purchase information allow the user to communicate naturally with the product, via the voice assistant, and also allows the voice assistant to remove ambiguity associated with general queries where the missing information can simply be the product name or model.

One or more devices communicatively interfacing with appropriate permissions (e.g., for access to metadata or other data used to characterize or target individual users of personal devices for current or future advertising) that a purchaser has configured for personal use may be set up for remote upgrades and actions based on product status (e.g., where appropriate permissions are enabled). Accordingly, an auto-configuration feature that sets up advertisement queries and permissions based on search inputs provided by the purchaser (e.g., related to purchased products that trigger display of new models of purchased products). Going back to the stove example above, where the purchaser ends up replacing an old stove with a new stove, instructions related to pertinent or desirable new features may be searched for on an automated basis. In response to the pertinent searches (e.g., as stored by a smart home application or other search history), particular instructions may be retrieved based on the latest purchased model of the stove. Additionally, or alternatively, prompts (e.g., commands) may be searched for in order to increase ease of use of the new model. For example, a smart home system may identify stove commands related to setting a timer or preheating, based on available commands and smart device capabilities of the new stove (e.g., including devices communicatively coupled to the stove to improve smart capabilities thereby). Manufacturers may, for example, have a set of preconfigured “skills” that when activated by an appropriate prompt (e.g., “stove-set timer for 10 minutes”) activate the desired features of the purchaser. In some embodiments, a smart home interface may present an overlay or verbal query to the purchaser along the lines of “would you like to set a timer on the stove” in order to confirm an automatically computed intent based on express input from the purchaser. Accordingly, e-commerce platforms paired with search algorithms, intent engines, and manufacturer data bases can be configured, based on the various strategies discussed herein, to provide comfort to a purchaser that a recent purchase can align with their needs for making the purchase. Additionally, if the smart voice assistant has access to the user's purchase history or the product that the user owns, then the ‘skill name’ maybe not be needed to perform an action such as preheating an oven. In such case, a wake command followed by a query, suffices. This is because the intent module associated with the voice assistant is able to determine which skill or 3^{rd} party application to invoke or communicate with to execute the command or respond to the user's query.

FIG. 1B depicts information flow 100B across multiple devices in order to present a purchaser and an associate of the purchaser with advertisements related to different features of a product that the purchaser has use data for, in accordance with some embodiments of the disclosure. Information flow 100B corresponds to at least one embodiment of the transmission of data during execution of advertising scenario 100A, and may be executed, in whole or in part, using one or more of the elements of the system of FIG. 2A or the device of FIG. 2B. Information flow 100B may be enabled by execution of one or more elements of process 300 of FIG. 3, process 400 of FIG. 4, or process 500 of FIG. 5 (e.g., by use of one or more elements of the system of FIG. 2A or the device of FIG. 2B).

A customer, or purchaser, may not know of or may not have felt the need to use important features of the product they have purchased. The purchaser, therefore, would not derive the full value of the product and thus may be less satisfied than the purchaser could be if the purchaser was aware of and using all pertinent features of the purchased product. In the interest of retention of an existing purchaser, the purchaser may not desire an upgraded version of the product due current or remaining dissatisfaction with the purchased product. As such, this post-sale situation is common and vendors, or manufacturers, may utilize the systems and methods of this disclosure to ensure “product stickiness” where purchasers retain products and effectively advertise the products and features to associates. This is particularly desirable for consumer products like home appliances, complex electronics, and automobiles. All of these have dozens of features that are likely learned over an ownership period of the purchaser. Current approaches considered as deficient in view of the systems of method of this disclosure include bombarding advertisement campaigns across multiple interfaces and communication streams while also utilizing “referral marketing” and “influencer marketing” that target individuals who may know potential buyers. The approach characterized by information flow 100B provides an intelligent, direct, and focused approach to individuals not previously subjected to advertisements related to a product, thereby improving likelihood of existing purchaser retention with a possibility of gaining a new purchaser.

Information flow 100B is, in some embodiments, enabled based on an interfacing, or exchange of data, between vendor 132, purchaser 134, product usage log 136, advertisement platform 138, purchaser's contacts 104, and purchaser's associate 142. Any or all of these IoT platform components may be a smart device, or a data structure associated with one or more communicatively coupled smart devices (e.g., computing device 202 of FIGS. 2A and 2B). In some embodiments, the information exchanged between or provided by one or more of the aforementioned IoT platform components may incorporate extended reality elements, which are subjected to scene analysis for advertisement or reminder placement. Additionally, or alternatively, social media posts or activity related thereto may be used to identify one or more use patterns of a purchaser of one more features of a product. These elements of collected data may be utilized through information flow 100B in order to create a more personalized or immersive advertisement experience tailored to purchaser activity and pertinent associates as identified based on streams of communication between the purchaser and the associate of the purchaser.

In some embodiments, an advertisement server corresponding to advertisement platform 138 may be communicatively coupled to, or otherwise communicatively linked, to a social network. As a result, advertisement platform 138 may be the subject of requests for advertisements for the purchaser and requests for advertisements for the associate of the purchaser across one or more social media interfaces (e.g., different applications on different devices). The advertisement server may then be configured to generate and provide two different advertisements, where the different advertisements are based on one or more elements of demographic information. For example, the purchaser may have a first set of demographic information and the associate may have a second set of demographic information, where the second set of demographic information has at least one element different from the first set of demographic information (e.g., the associate is not a purchaser of a product from a particular manufacturer). Accordingly, a first advertisement is presented to the purchaser based on the first set of demographic information whereas a second advertisement is presented to the associate based on the second set of demographic information. Additionally, or alternatively, social media platforms and search engines may be linked based on data sharing permissions such that the advertisement platform is queried for different advertisements based on one or more of demographic information of the purchaser, demographic information of the associate, communications between the purchaser and the associate, searches related to a purchased model conducted by the purchaser, or intent derived from any of the aforementioned elements.

As shown in FIG. 1B, vendor 132 provides postings or listings for one or more of product 144 (e.g., on an eCommerce platform or other product listing interface). Based on product 144, advertisement platform 138 generates feature and teaser advertisements, via process block 146, for product 144. For example, a feature advertisement would identify a particular element of the product (e.g., a feature) that either characterizes a predominant use of product 144 or a trending benefit of product 144 while a teaser advertisement would be directed to capturing attention of potential purchasers without defining particular details of one or more features of operation of product 144. Purchaser 134 then purchases product 144 (e.g., based on a feature advertisement generated and transmitted via process block 146) at process block 148. Vendor 132 is able to identify the purchaser via process block 150 (e.g., based on contact information or purchaser information acquired via the transaction between purchaser 134 and vendor 132 for product 144).

Once purchaser 134 acquires product 144 and vendor 132 has identified purchaser 134 based on the transaction, a plurality of data is exchanged between different layers of information flow 100B to generate the advertisement cascade of this disclosure. Purchaser 134 generates streams of communication via process block 154 with, for example, purchaser's associate 142 via chat applications or other smart device streams of communication. In some embodiments, the streams of communication are directed to product 144 or interactions with one or more features of product 144. Additionally, or alternatively, process block 154 also generates interaction data that characterizes the interaction between purchaser 134 and product 144. The interaction data is collected via process block 152 for storage via product usage log 136. Product usage log 136 corresponds to purchaser use log of features 112 of FIG. 1A. Product usage log 136 may be stored locally (e.g., via a user's smart device or product 144) or may be stored on a server (e.g., as enabled by an IoT platform). The identity of the purchaser (e.g., as identified via process block 150 using transaction data), the data from product usage log 136 (e.g., indications of which features of product 144 are used by purchaser 134), and purchaser's contacts 140 are all transmitted to or retrieved by advertisement platform 138. For example, purchaser's contacts 140 may be a list of purchaser contacts from one or more applications on an end user device of the purchaser or stored phone numbers on the end user device that are retrieved via process block 158 for transmission to advertisement platform 138.

In response to advertisement platform 138 receiving information via process blocks 150, 152, and 158, a feature advertisement for one or more features of product 144 unused by purchaser 134 is transmitted for display at an end user device of purchaser 134 via process block 156. The feature advertisement may be previously generated in response to product 144 being listed for purchaser via vendor 132. In some embodiments, the feature advertisement is generated via advertisement platform 138 in response to the data received via process blocks 150, 152, and 158. Additionally, or alternatively, advertisement platform 138 identifies purchaser's associate 142 via process block 160 based at least on the contact information received via advertisement platform 138 using process block 158, which involves accessing purchaser's contacts 140 (e.g., from an end user device of purchaser 134 or via product 144 which may be communicatively coupled to the purchaser's end user device with permission to access contact information). Process block 160 also includes the filter of determining that purchaser's associate 142 was not previously targeted via advertisement platform 138 for feature or teaser advertisements corresponding to product 144. For example, purchaser's associate 142 may be outside a target demographic or may not be included in a network of products that would otherwise flag purchaser's associate 142 as being part of a recent advertisement campaign. Once purchaser's associate 142 is identified, one or more of process block 162, for transmitting a teaser advertisement for unused features of product 144 (e.g., unused by purchaser 134), or process block 164, for transmitting a teaser advertisement for used features of product 144 (e.g., as used by purchaser 134 based on data from product usage log 136) is used to present one or more advertisements to purchaser's associate 142.

In some embodiments, information flow 100B may be applicable to a scenario where purchaser 134 purchased product 144 due to the recency of the release of the product and product 144 is considered a means to stand out among a social circle. Depending on the parameters of an advertisement campaign generated by advertisement platform 138, members of a social circle of purchaser 134 (e.g., including purchaser's associate 142 and as characterized by purchaser's contacts 140) would not be shown advertisements for product 144 unless the members of the social circle are in a target group defined by the advertisement campaign of advertisement platform 138. Information flow 100B is intended to remedy the issue of members of the purchaser's social circle lacking knowledge of product 144 and the benefits of features thereof. Accordingly, information flow 100B provides a means to attract new purchasers beyond purchaser 134 while also reinforcing the merits of the purchase of product 144 to purchaser 134.

Advertising companies and platforms are aware of no-sale situations. For example, a purchaser of a product configured for a first operating system (e.g., Android) may not be enticed to convert to a product configured for a second operating system (e.g., iPhone). Accordingly, the purchaser of the product for the first operating system would likely be excluded from one or more advertisement campaigns for the product compatible with the second operating system. Information flow 100B remedies this issue by creating a means to identify purchaser associates who can be presented one or more of the teaser advertisements of this disclosure to introduce a useful feature not previously considered (e.g., device or network linking capability differences between products and operating systems). Information flow 100B also applies to scenarios where a purchaser and an associate thereof discuss a current use of a product that will eventually apply to the associate (e.g., products for a toddler the purchaser has that the associate, who has an infant, is not currently in the market for, but soon will be) and the teaser advertisements of this disclosure provide a means to spark interest from the associate in the product leading up to a potential need for the product by the associate.

FIG. 2A depicts system 200 capable of executing the methods of this disclosure, in accordance with some embodiments of the disclosure. System 200 may be configured to execute advertising scenario 100A of FIG. 1A (e.g., where one or more of purchaser's device 102 or device of purchaser's associate 124 of FIG. 1A is used as computing device 202 of FIGS. 2A and 2B) and may include various implementations of processing circuitry across one or more devices to execute any or all of, in whole or in part, the methods depicted in and described in reference to FIGS. 3-5. System 200 is shown to include a computing device 202, a server 204 and a communication network 206. It is understood that while a single instance of a component may be shown and described relative to FIG. 2, additional instances of the component may be employed. For example, server 204 may include, or may be incorporated in, more than one server. Similarly, communication network 206 may include, or may be incorporated in, more than one communication network. Server 204 is shown communicatively coupled to computing device 202 through communication network 206. While not shown in FIG. 2, server 204 may be directly communicatively coupled to computing device 202, for example, in a system absent or bypassing communication network 206.

Communication network 206 may comprise one or more network systems, such as, without limitation, an internet, LAN, WIFI or other network systems suitable for audio processing applications. In some embodiments, system 200 excludes server 204, and functionality that would otherwise be implemented by server 204 is instead implemented by other components of system 200, such as one or more components of communication network 206. In still other embodiments, server 204 works in conjunction with one or more components of communication network 206 to implement certain functionality described herein in a distributed or cooperative manner. Similarly, in some embodiments, system 200 excludes computing device 202, and functionality that would otherwise be implemented by computing device 202 is instead implemented by other components of system 200, such as one or more components of communication network 206 or server 204 or a combination. In still other embodiments, computing device 202 works in conjunction with one or more components of communication network 206 or server 204 to implement certain functionality described herein in a distributed or cooperative manner.

Computing device 202 includes control circuitry 208, display 210 and input circuitry 212. Control circuitry 208 in turn includes communication circuitry 226, storage 222 and processing circuitry 218. In some embodiments, computing device 202 or control circuitry 208 may be configured as computing device 202 of FIG. 2B.

Server 204 includes control circuitry 234 and storage 238. Each of storages 222 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 222, 238 may be used to store various types of content, metadata, and or other types of data (e.g., they can be used to store user statistics or group statistics, user and plurality of user performance data or user performance metric, data relating to home automation devices and their settings and any user preferences, lists of recommendations and remedial actions, ML algorithms, and AI algorithms). Non-volatile memory may also be used (e.g., to launch a boot-up routine and other instructions). Cloud-based storage may be used to supplement storages 222, 238 or instead of storages 222, 238. In some embodiments, data characterized through a user device, a profile affiliated with a user device, or data retrievable and transmittable to a generative AI engine, and data relating to all other processes and features described herein, may be recorded and stored in one or more of storages 222, 238 (e.g., for generating elements of an advertisement campaign such as one or more of feature or teaser advertisements).

In some embodiments, control circuitry 234 and/or 208 executes instructions for an application (e.g., an eCommerce application or other application configured to generate overlays for advertisement spaces or other interfaces with space for advertisements) stored in memory (e.g., storage 238 and/or storage 222). Specifically, control circuitry 234 and/or 208 may be instructed by the application to perform the functions discussed herein. In some implementations, any action performed by control circuitry 234 and/or 208 may be based on instructions received from the application. For example, the application may be implemented as software or a set of executable instructions that may be stored in storage 238 and/or 222 and executed by control circuitry 234 and/or 208. In some embodiments, the application may be a client/server application where only a client application resides on computing device 202, and a server application resides on server 204.

The application may be implemented using any suitable architecture. For example, it may be a stand-alone application wholly implemented on computing device 202. In such an approach, instructions for the application are stored locally (e.g., in storage 222), and data for use by the application is downloaded on a periodic basis (e.g., from an out-of-band feed, from an internet resource, or using another suitable approach). Control circuitry 208 may retrieve instructions for the application from storage 222 and process the instructions to perform the functionality described herein. Based on the processed instructions, control circuitry 208 may determine a type of action to perform in response to input received from input circuitry 212 or from communication network 206. Other such processes are described in FIGS. 3-5.

In client/server-based embodiments, control circuitry 208 may include communication circuitry suitable for communicating with an application server (e.g., server 204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 206). In another example of a client/server-based application, control circuitry 208 runs a web browser that interprets web pages provided by a remote server (e.g., server 204). For example, the remote server may store the instructions for the application in a storage device. The remote server may process the stored instructions using circuitry (e.g., control circuitry 208) and/or generate displays. Computing device 202 may receive the displays generated by the remote server and may display the content of the displays locally via display 210. This way, the processing of the instructions is performed remotely (e.g., by server 204) while the resulting displays, such as the display windows described elsewhere herein, are provided locally on computing device 202. Computing device 202 may receive inputs from the user via input circuitry 212 and transmit those inputs to the remote server for processing and generating the corresponding displays. Alternatively, computing device 202 may receive inputs from the user via input circuitry 212 and process and display the received inputs locally, by control circuitry 208 and display 210, respectively.

Server 204 and computing device 202 may transmit and receive content and data such as objects, frames, snippets of interest, and input from primary devices and secondary devices, such as speakers, LED displays or arrangements, monitors of smart home devices or audio-video device, or one or more of AR or XR devices. Control circuitry 234, 208 may send and receive commands, requests, and other suitable data through communication network 206. Control circuitry 234, 208 may communicate directly with each other using communication circuitry 226 and 232, respectively, avoiding communication network 206.

It is understood that computing device 202 is not limited to the embodiments and methods shown and described herein. In nonlimiting examples, computing device 202 may be a virtual, augmented, or mixed reality headset, smart glasses, or a device that can perform function in the metaverse (e.g., as shown in FIGS. 1 and 2B), a primary device, a personal computer (PC), a laptop computer, a tablet computer, a WebTV box, a personal computer television (PC/TV), a PC media server, a PC media center, a handheld computer, a mobile telephone, a smartphone, or any other device, computing equipment, or wireless device, and/or combination of the same capable of suitably displaying primary content and secondary content.

Control circuitry 234 and/or 208 may be based on any suitable processing circuitry such as processing circuitry 218 and/or 236, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 234 and/or control circuitry 208 are configured to render one or more elements of supplemental content corresponding to a product icon described throughout this disclosure (e.g., audio content, visible content, XR immersive content corresponding to one or more advertisement elements of this disclosure).

User input 204 may be received from virtual, augmented, or mixed reality headsets, mobile data, smart glasses. Transmission of user input 204 to computing device 202 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, 5G, or any other suitable wireless transmission protocol. Input circuitry 212 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, 5G, or other wireless transmission protocols.

Processing circuitry 218 may receive input 204 from input circuit 212. Processing circuitry 218 may convert or translate the received user input 204 that may be in the form of voice input into a microphone, or movement or gestures to digital signals. In some embodiments, input circuit 212 performs the translation to digital signals. In some embodiments, processing circuitry 218 (or processing circuitry 236, as the case may be) carries out disclosed processes and methods. For example, processing circuitry 218 or processing circuitry 236 may perform processes as described in reference to FIGS. 3-5.

FIG. 2B depicts computing device 202 of system 200 configured to be integrated into the system of FIG. 2A for executing the methods of this disclosure, in accordance with some embodiments of the disclosure. Computing device 202 may be configured to executed advertising scenario 100A of FIG. 1A (e.g., where one or more of purchaser's device 102 or device of purchaser's associate 124 of FIG. 1A is used as computing device 202 of FIGS. 2A and 2B) and may include various implementations of processing circuitry across one or more devices to execute any or all of, in whole or in part, the methods depicted in and described in reference to FIGS. 3-5.

Computing device 202 may be a smartphone device, a tablet, a virtual reality or augmented reality device, or any other suitable device capable of processing data corresponding to an e-commerce application and related supplemental content described in this disclosure. In another example, a user equipment device, such as a user television equipment system or streaming interface device, may include media access device 256. Media access device 256 may be communicatively connected to haptic enabled headset 258, audio input equipment (e.g., headset microphone 260), and display 210. In some embodiments, display 210 may be a television display or a computer display. In some embodiments, display 210 may be a display in an HMD or an XR device. As shown in FIG. 2B, display 210 may be communicatively coupled to or may comprise head mounted display 262, which also is shown in FIG. 2B as being communicatively coupled to one or more of user input interface 264 (e.g., may display user input interface 264 with capabilities to receive user inputs via input/output circuitry 212 of FIG. 2A) or haptic feedback hand devices 270 (e.g., configured to enable a user to provide inputs to user input interface 268 or display 210 as the user would by a remote or a communicatively coupled computer mouse or joystick), while also being communicatively coupled to media access device 256. In some embodiments, user input interface 268 may be a remote-control device. Media access device 256 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path.

Each one of computing device 202 and user equipment device 801 may receive content and data via input/output (I/O) path (e.g., circuitry) 266, which may communicatively interface with head mounted display 262. I/O path 266 may provide content (e.g., broadcast programming, on-demand programming, Internet content, content available over a local area network (LAN) or wide area network (WAN), and/or other content) and data to control circuitry 208, which may comprise processing circuitry 218 and storage 222 of FIG. 2A. Control circuitry 208 may be used to send and receive commands, requests, and other suitable data using I/O path 266, which may comprise I/O circuitry. I/O path 266 may connect control circuitry 208 (and specifically processing circuitry 218) to one or more communications paths (described below). I/O functions may be provided by one or more of these communications paths, but are shown as a single path in FIG. 2B to avoid overcomplicating the drawing. While media access device 256 is shown in FIG. 2B for illustration, any suitable computing device having processing circuitry, control circuitry, and storage may be used in accordance with the present disclosure. For example, media access device 256 may be replaced by, or complemented by, a personal computer (e.g., a notebook, a laptop, a desktop), a smartphone (e.g., device 202), a tablet, a network-based server hosting a user-accessible client device, a non-user-owned device, any other suitable device, or any combination thereof.

Control circuitry 208 may be based on any suitable control circuitry such as processing circuitry 218. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 208 executes instructions for an immersive advertisement insertion application or algorithm paired with one or more other entertainment applications stored in memory (e.g., storage 222 or 238 of FIG. 2A). Specifically, control circuitry 208 may be instructed by the immersive video application to perform the functions discussed above and below. In some implementations, processing or actions performed by control circuitry 208 may be based on instructions received from the immersive advertisement insertion application or algorithm paired with one or more other entertainment applications.

In client/server-based embodiments, control circuitry 208 may include communications circuitry suitable for communicating with a server or other networks or servers. The immersive advertisement insertion application or algorithm paired with one or more other entertainment applications may be a stand-alone application implemented on a device or a server. The immersive advertisement insertion application or algorithm paired with one or more other entertainment applications may be implemented as software or a set of executable instructions. The instructions for performing any of the embodiments discussed herein of the immersive advertisement insertion application or algorithm paired with one or more other entertainment applications may be encoded on non-transitory computer-readable media (e.g., a hard drive, random-access memory on a DRAM integrated circuit, read-only memory on a BLU-RAY disk, etc.). For example, in FIG. 2B, the instructions may be executed by control circuitry 208 of computing device 202 while being stored via one or more processors shown in FIG. 2A.

In some embodiments, immersive advertisement insertion application or algorithm paired with one or more other entertainment applications may be a client/server application where only the client application resides on computing device 202, and a server application resides on an external server (e.g., server 204 of FIG. 2A). For example, immersive advertisement insertion application or algorithm paired with one or more other entertainment applications may be implemented partially as a client application on control circuitry 208 of computing device 202 and partially on server 204 as a server application running on control circuitry 234. Server 204 may be a part of a local area network with one or more computing devices 202 or may be part of a cloud computing environment accessed via the internet. In a cloud computing environment, various types of computing services for performing searches on the internet or informational databases, providing seamless virtual space traversing capabilities, providing storage (e.g., for a database) or parsing data (e.g., using machine learning algorithms) are provided by a collection of network-accessible computing and storage resources (e.g., server 204 and multiples of computing device 202), referred to as “the cloud.” Computing device 202 may be a cloud client that relies on the cloud computing capabilities from server 204 to determine whether processing (e.g., at least a portion of virtual background processing and/or at least a portion of other processing tasks) should be offloaded from the mobile device, and facilitate such offloading. When executed by control circuitry of server 204, immersive advertisement insertion application or algorithm paired with one or more other entertainment applications may instruct control circuitry 234 or 208 to perform processing tasks for the client device and facilitate one or more of the seamless virtual space traversing, product purchasing, or advertisement interaction.

Control circuitry 208 may include communications circuitry suitable for communicating with a server, edge computing systems and devices, a table or database server, or other networks or servers. The instructions for carrying out the above mentioned functionality may be stored on a server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths. In addition, communications circuitry may include circuitry that enables peer-to-peer communication of user equipment devices, or communication of user equipment devices in locations remote from each other (described in more detail below).

Memory may be an electronic storage device that is part of control circuitry 208. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. The storage may be used to store various types of content described herein as well as immersive video application data described above. Nonvolatile memory may also be used (e.g., to launch a boot-up routine and other instructions). Cloud-based storage may also be used to supplement storage 238 of FIG. 2A or instead of storage 222.

Control circuitry 208 may include video generating circuitry and tuning circuitry, such as one or more analog tuners, one or more video decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 208 may also include scaler circuitry for up converting and down converting content into the preferred output format of computing device 202. Control circuitry 208 may also include digital-to-analog converter circuitry and analog-to-digital converter circuitry for converting between digital and analog signals. The tuning and encoding circuitry may be used by computing device 202 to receive and to display, to play, or to record content. The tuning and encoding circuitry may also be used to receive video data for seamless interspace traversing. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage is provided as a separate device from computing device 202, the tuning and encoding circuitry (including multiple tuners) may be associated with the storage.

Control circuitry 208 may receive instruction from a user by way of user input interface 264. User input interface 264 may be any suitable user interface, such as a remote control, mouse, trackball, keypad, keyboard, touch screen, touchpad, stylus input, joystick, voice recognition interface, or other user input interfaces (e.g., an interface configured to receive inputs from haptic feedback hand devices 270). Display 210 may be provided as a stand-alone device or integrated with other elements of each one of computing device 202. For example, display 210 may be a touchscreen or touch-sensitive display. In such circumstances, user input interface 264 may be integrated with or combined with display 210 (e.g., where haptic feedback hand devices 270 is configured to enable a user to interact with or manipulate aspects of a media asset interface displayed via head mounted display 262). In some embodiments, user input interface 264 includes a remote-control device having one or more microphones, buttons, keypads, and any other components configured to receive user input or combinations thereof. For example, user input interface 264 may include a handheld remote-control device having an alphanumeric keypad and option buttons (e.g., haptic feedback hand devices 270). In a further example, user input interface 264 may include a handheld remote-control device having a microphone and control circuitry configured to receive and identify voice commands and transmit information to media access device 256.

Headset microphone 260 may be integrated with or combined with display 210. Display 210 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 210. Headset microphone 260 may be provided as integrated with other elements of each one of computing device 202 or may be stand-alone units. An audio component of videos and other content displayed on display 210 may be played through speakers (or headphones) of haptic enabled headset 258. In some embodiments, audio may be distributed to a receiver (not shown), which processes and outputs the audio via speakers of haptic enabled headset 258. In some embodiments, for example, control circuitry 208 is configured to provide audio cues to a user, or other audio feedback to a user, using speakers of haptic enabled headset 258. There may be a separate haptic enabled headset 258 or headset microphone 260 may include a microphone configured to receive audio input such as voice commands or speech. For example, a user may speak letters or words that are received by the microphone and converted to text by control circuitry 208. In a further example, a user may voice commands that are received by a microphone and recognized by control circuitry 208. Recording device 268 may be any suitable video camera integrated with the equipment or externally connected. Recording device 268 may be a digital camera comprising a charge-coupled device (CCD) and/or a complementary metal-oxide semiconductor (CMOS) image sensor. Recording device 268 may be an analog camera that converts to digital images via a video card.

An application configured to provide a user access to an e-commerce platform and also provide rendering instructions for various elements of advertisements to secondary subsystems, systems, or devices, or one communicatively coupled to a generative AI engine for generating advertising content for one or more of the purchasers or associates of this disclosure, may be implemented using any suitable architecture. For example, it may be a stand-alone application wholly implemented on each one of computing device 202. In such an approach, instructions of the application may be stored locally, and data for use by the application is downloaded on a periodic basis (e.g., from an out-of-band feed, from an Internet resource, or using another suitable approach). Control circuitry 208 may retrieve instructions of the application from storage and process the instructions to provide seamless interspace traversing functionality and perform any of the actions discussed herein. Based on the processed instructions, control circuitry 208 may determine what action to perform when input is received from user input interface 264. For example, movement of a cursor on a display up/down may be indicated by the processed instructions when user input interface 264 indicates that an up/down button was selected (e.g., based on inputs provided via haptic feedback hand devices 270). An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

In some embodiments, the application is a client/server-based application. Data for use by a thick or thin client implemented on each one of computing device 202 and may be retrieved on-demand by issuing requests to a server remote to each one of computing device 202. For example, the remote server may store the instructions for the application in a storage device. The remote server may process the stored instructions using circuitry (e.g., control circuitry 208) and generate the displays discussed above and below. The client device may receive the displays generated by the remote server and may display the content of the displays locally on computing device 202. This way, the processing of the instructions is performed remotely by the server while the resulting displays (e.g., that may include text, a keyboard, or other visuals) are provided locally on computing device 202. Computing device 202 may receive inputs from the user via input interface 264 and transmit those inputs to the remote server for processing and generating the corresponding displays. For example, computing device 202 may transmit a communication to the remote server indicating that an up/down button was selected via input interface 264 (e.g., based on one or more inputs provided via one or more of haptic feedback hand devices 270 or head mounted display 262). The remote server may process instructions in accordance with that input and generate a display of the application corresponding to the input (e.g., a display that moves a cursor up/down). The generated display is then transmitted to a communicatively accessible device for presentation to the user.

In some embodiments, immersive advertisement insertion application or algorithm paired with one or more other entertainment applications may be downloaded and interpreted or otherwise run by an interpreter or virtual machine (run by control circuitry 208). In some embodiments, the immersive advertisement insertion application or algorithm paired with one or more other entertainment applications may be encoded in the ETV Binary Interchange Format (EBIF), received by control circuitry 208 as part of a suitable feed, and interpreted by a user agent running on control circuitry 208. For example, the immersive advertisement insertion application or algorithm paired with one or more other entertainment applications may be an EBIF application. In some embodiments, the immersive advertisement insertion application or algorithm paired with one or more other entertainment applications may be defined by a series of JAVA-based files that are received and run by a local virtual machine or other suitable middleware executed by control circuitry 208. In some of such embodiments (e.g., those employing MPEG-2 or other digital media encoding schemes), the immersive advertisement insertion application or algorithm paired with one or more other entertainment applications may be, for example, encoded and transmitted in an MPEG-2 object carousel with the MPEG audio and video packets of a program.

In some embodiments, the immersive advertisement insertion application or algorithm paired with one or more other entertainment applications is configured to activate one or more monitoring or data collecting elements of an immersive system that includes one or more of cameras, microphones, or haptic feedback devices to identify products. For example, the immersive system may be configured to identify a purchaser has a product and the product has a particular model and manufacturer. As a result, the advertisement application or insertion algorithm may utilize data from the immersive system to identify a new version of the product that is either compatible with a different current product of the user (e.g., a new smart toothbrush is compatible with a current phone of the purchaser) or a newer model of the different current product has compatibility with the purchased item (e.g., the purchased smart toothbrush has more features unlocked with a newer model of the purchaser's current phone). In either scenario, the systems and methods of this disclosure are configured to identify products, use patterns, and compatibility, both forwards and in reverse with respect to current models on the market, which will then be provided as inputs for advertisement strategies.

FIG. 3 depicts is a block diagram representing advertising process 300 for presenting feature advertisements of a product to an associate of a purchaser of the product, in accordance with some embodiments of the disclosure. Advertising process 300 corresponds to execution of advertising scenario 100A of FIG. 1A and may be enabled by information flow 100B of FIG. 1B. Advertising process 300 may be executed, in whole or in part, by any or all of the devices depicted or described in reference to FIGS. 1A-2B. Advertising process 300 may be executed separately from, in parallel to, or as part of process 400 of FIG. 4 (e.g., starting at process block 402) or process 500 of FIG. 5 (e.g., starting at process block 502).

At process block 302, at least one feature advertisement is retrieved from one or more servers, wherein the at least one feature advertisement corresponds to one or more product features of a new model of a product purchased by the purchaser and the at least one feature advertisement is directed to a first group of product features (e.g., the product features described in reference to FIG. 1A). At process block 304, at least one teaser advertisement is retrieved from the one or more servers, wherein the at least one teaser advertisement corresponds to one or more other product features of the new model and the at least one teaser advertisement is directed to a second group of product features (e.g., the product features described in reference to FIG. 1A). In some embodiments, the one or more product features comprise one or more of features or uses of a product that are modified via at least one replacement product (e.g., a new model of a purchased product).

Decision block 306 is used to determine whether the purchase has at least one stored contact on at least one device (e.g., a device used to purchase products via an eCommerce application or interface). If it is determined that the purchaser does not have any stored contacts (NO at 306), then advertising process 300 ends. In some embodiments, the stored contacts may be supplemented using metadata tags or other information discernable from virtual reality or smart assistant device that are configured to generated identification for one or more individuals within a particular area. Where such smart home immersive systems are utilized, advertising process 300 may process to process block 308 if a device can be identified of an associate of the purchaser and the device has access to demographic information of the associate of the purchaser. If it is determined that the purchaser does have at least one stored contact on at least one device (YES at 306), then advertising process 300 proceeds to process block 308.

At process block 308, a data structure is identified corresponding to the associated viewer based a communication history characterized by data exchanges between a device of the purchaser and a device of the associated viewer. The data structure may comprise criteria of the associated viewer indicative of the associated viewer being outside a target advertising pool of at least one advertiser with administrative access to the one or more servers. In some embodiments, the one or more product features are identified based on processing of one or more of verbal exchanges or written exchanges accessible via one or more of the device of the purchaser or the device of the associated viewer (e.g., where process block 308 is executed as part of a feedback loop for process blocks 302 and 304). Additionally, or alternatively, the verbal exchanges or the written exchanges comprise one or more indications of a desire for an improvement of a product comprising the one or more product features.

Decision block 310 is used to determine if the associated viewer is part of an advertising pool for a product corresponding to the relevant product features. If it is determined the associated user is part of the target advertising pool (YES at 310), then advertising process 300 ends. If it is determined the associated user is not part of the target advertising pool (NO at 310), then advertising process 300 proceeds to process block 312. At process block 312, a first product feature of the first group of product features is identified. Additionally, or alternatively, a second product feature of the second group of product features is identified. Process blocks 314A and 314B may be executed contemporaneously or one before the other depending on various advertisement campaign parameters or device settings. At process block 314A, the at least one feature advertisement based on the first product feature is displayed via a device of the purchaser. At process block 314B, the at least one teaser advertisement based on the second product feature is displayed via a device of the associated viewer.

FIG. 4 depicts is a block diagram representing advertising process 400 for identifying product features to advertise, in accordance with some embodiments of the disclosure. Advertising process 400 corresponds to execution of advertising scenario 100A of FIG. 1A and may be enabled by information flow 100B of FIG. 1B. Advertising process 400 may be executed, in whole or in part, by any or all of the devices depicted or described in reference to FIGS. 1A-2B. Advertising process 400 may be executed separately from, in parallel to, or as part of process 300 of FIG. 3 (e.g., starting at process block 312) or process 500 of FIG. 5 (e.g., starting at process block 502).

At process block 402, one or more of a query or a prompt is received (e.g., via an end user device that is communicatively coupled to a server) corresponding to a request for a list of products via a device of the purchaser. In some embodiments, the prompt is generated by an artificial intelligence generative engine based on one or more elements of the query. Additionally, and alternatively, the prompt causes processing circuitry to retrieve the list of products based on one or more of a connection status or connection strength between one or more communicatively accessible servers and the user device. At process block 404, a relevant purchase history is identified based on one or more of the query or the prompt. In some embodiments, the relevant purchase history is identified based on one or more functions associated with the at least one product. Additionally, or alternatively, the relevant purchase history is identified based on information acquired from one or more of advertisements or product reviews associated with the at least one product. At process block 406, the relevant purchase history is compared to the list of products. At process block 408, at least one product of the list of products is determined, based on the comparing, to have previously been purchased. At process block 410, the one or more product features is identified from a data structure corresponding to the at least one product.

FIG. 5 depicts is a block diagram representing advertising process 500 for presenting teaser advertisements of a product to an associate of a purchaser of the product, in accordance with some embodiments of the disclosure. Advertising process 500 corresponds to execution of advertising scenario 100A of FIG. 1A and may be enabled by information flow 100B of FIG. 1B. Advertising process 500 may be executed, in whole or in part, by any or all of the devices depicted or described in reference to FIGS. 1A-2B. Advertising process 500 may be executed separately from, in parallel to, or as part of process 300 of FIG. 3 (e.g., starting at process block 312) or process 400 of FIG. 4 (e.g., starting at process block 404).

At process block 502, at least one product comprising the one or more product features that was purchased by the purchaser is identified. At process block 504, a data structure comprised of the data stored in memory is retrieved from a product usage server that is indicative of one or more use patterns of the at least one product. In some embodiments, the one or more use patterns are characterized by the data stored in memory. Additionally, or alternatively, the data stored in memory, when processed by the processing circuitry, comprises indications of the one or more product features being unused or the one or more product features being inefficiently used. The data stored in memory comprised of information indicative of one or more use patterns of the at least one product is generated based on one or more of user interaction data associated with a device interface of the at least one product, data generated from one or more of videos or pictures of the purchaser interacting with the at least one product, or indications of use of the at least one product generated from processing of one or more of verbal exchanges or exchanges of strings of characters between the purchaser and the associated viewer, wherein the one or more verbal exchanges or exchanges of strings of characters comprise at least one mention of the at least one product.

At process block 506, the at least one product is determined, based on the one or more use patterns, to correspond to a probability score that indicates the user will either replace the product or dispose of the product. For example, the probability score may be computed based on various advertisement metrics including frequency of use, effectivity of use, express indications of purchaser satisfaction (e.g., via one or more communication interfaces or analysis of purchaser behavior via a smart home system), or indications of synchronization between devices of the purchaser. The score may be a decimal or scalar value that may be utilized to increase or decrease a weight of a product or a feature of a product for generating an advertisement campaign. At process block 508, an updated probability score is computed based on interaction of the associated viewer with one or more of the first teaser advertisement or the second teaser advertisement. At process block 510, the updated probability score is compared to the probability score. At process block 512, at least one data structure corresponding to rendering criteria for one or more of the first teaser advertisement or the second teaser advertisement is retrieved in response to determining the updated probability score exceeds the probability score.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

While some portions of this disclosure may refer to “convention” or examples, any such reference is merely to provide context to the instant disclosure and does not form any admission as to what constitutes the state of the art.

What is claimed is:

1. A method comprising:
monitoring, using a product application, for data indicating usage of product features associated with a product;
determining one or more feature use patterns based at least in part on the data indicating the usage of the product features associated with the product, wherein the one or more feature use patterns is stored by the product application;
receiving, by a search engine, a query relating to the product, wherein the search engine was previously authorized to access the data from the product application;
retrieving, using the search engine, the one or more feature use patterns stored by the product application; and
based at least in part on retrieving the one or more feature use patterns from the product application, using the search engine to:
identify a particular product feature indicated by the query, and
generate for display at least a portion of instructions for operation of the particular product feature.

2. The method of claim 1, wherein the generated at least a portion of the instructions for the operation of the particular product feature are associated with a user manual indicating a plurality of product features that would be useful to a user.

3. The method of claim 1, wherein the one or more feature use patterns indicates one or more features of the product that were used and one or more unused features of the product.

4. The method of claim 1, wherein the generated at least a portion of the instructions for the operation of the particular product feature comprises a plurality of videos, the method further comprising:
determining a presentation order of the plurality of videos based at least in part on the one or more feature use patterns; and
generating for display the plurality of videos based at least in part on the determined presentation order.

5. The method of claim 1, wherein receiving the query relating to the product comprises receiving one or more voice queries relating to the one or more feature use patterns.

6. The method of claim 1, wherein determining the one or more feature use patterns comprises processing of one or more of verbal exchanges or written exchanges received via one or more user devices associated with the product application, and wherein the verbal exchanges or the written exchanges comprise one or more indications of a desire for an improvement of a new product comprising the product features associated with the product.

7. The method of claim 1, further comprising:
accessing, using the search engine, a plurality of data structures associated with the product application;
based at least in part on accessing the plurality of data structures, determining a probability score indicating whether a user associated with the product application will replace or dispose of the product; and
based at least in part on the probability score, determining whether to generate a plurality of videos related to the at least a portion of the instructions for the operation of the particular product feature.

8. The method of claim 7, further comprising:
based at least in part on tracking one or more user interactions with the plurality of videos related to the at least portion of instructions for the operation of the particular product feature, computing an updated probability score;
comparing the updated probability score to the probability score; and
based at least in part on determining that the updated probability score exceeds the probability score, retrieving a particular data structure of the plurality of data structures associated with a product feature different from the particular product feature indicated by the query.

9. The method of claim 1, wherein the one or more feature use patterns are characterized by the data from the product application, and wherein the data, when processed by control circuitry, indicates one or more features of the product being inefficiently used.

10. The method of claim 1, wherein determining the one or more feature use patterns comprises analyzing at least one of: data indicating user interactions with a device interface of the product, data generated from one or more of videos or pictures of a user interacting with the product, or indications of use of the product generated from processing one or more of verbal exchanges or exchanges of strings of characters between one or more user devices associated with the product application, and wherein the one or more of verbal exchanges or exchanges of strings of characters comprise at least one mention of the product.

11. A system comprising:
a memory;
an input/output (I/O) circuitry; and
a control circuitry configured to:
monitor, using a product application, for data indicating usage of product features associated with a product, wherein the data is stored in the memory;
determine one or more feature use patterns based at least in part on the data indicating the usage of the product features associated with the product, wherein the one or more feature use patterns is stored by the product application;
wherein the I/O circuitry is configured to:
receive, by a search engine, a query relating to the product, wherein the search engine was previously authorized to access the data from the product application;
retrieve, using the search engine, the one or more feature use patterns stored by the product application; and
wherein the control circuitry is configured to:
based at least in part on retrieving the one or more feature use patterns from the product application, using the search engine to:
identify a particular product feature indicated by the query, and
generate for display at least a portion of instructions for operation of the particular product feature.

12. The system of claim 11, wherein the generated at least a portion of the instructions for the operation of the particular product feature are associated with a user manual indicating a plurality of product features that would be useful to a user.

13. The system of claim 11, wherein the one or more feature use patterns indicates one or more features of the product that were used and one or more unused features of the product.

14. The system of claim 11, wherein the generated at least a portion of the instructions for the operation of the particular product feature comprises a plurality of videos, and wherein the control circuitry is further configured to:
determine a presentation order of the plurality of videos based at least in part on the one or more feature use patterns; and
generate for display the plurality of videos based at least in part on the determined presentation order.

15. The system of claim 11, wherein the I/O circuitry is configured to receive the query relating to the product by receiving one or more voice queries relating to the one or more feature use patterns.

16. The system of claim 11, wherein the control circuitry is configured to determine the one or more feature use patterns by processing of one or more of verbal exchanges or written exchanges received via one or more user devices associated with the product application, and wherein the verbal exchanges or the written exchanges comprise one or more indications of a desire for an improvement of a new product comprising the product features associated with the product.

17. The system of claim 11, wherein the control circuitry is further configured to:
access, using the search engine, a plurality of data structures associated with the product application;
based at least in part on accessing the plurality of data structures, determine a probability score indicating whether a user associated with the product application will replace or dispose of the product; and
based at least in part on the probability score, determine whether to generate a plurality of videos related to the at least a portion of the instructions for the operation of the particular product feature.

18. The system of claim 17, wherein the control circuitry is further configured to:
based at least in part on tracking one or more user interactions with the plurality of videos related to the at least portion of instructions for the operation of the particular product feature, compute an updated probability score;
compare the updated probability score to the probability score; and
based at least in part on determining that the updated probability score exceeds the probability score, retrieve a particular data structure of the plurality of data structures associated with a product feature different from the particular product feature indicated by the query.

19. The system of claim 11, wherein the one or more feature use patterns are characterized by the data from the product application, and wherein the data, when processed by the control circuitry, indicates one or more features of the product being inefficiently used.

20. The system of claim 11, wherein the control circuitry is configured to determine the one or more feature use patterns by analyzing at least one of: data indicating user interactions with a device interface of the product, data generated from one or more of videos or pictures of a user interacting with the product, or indications of use of the product generated from processing one or more of verbal exchanges or exchanges of strings of characters between one or more user devices associated with the product application, and wherein the one or more of verbal exchanges or exchanges of strings of characters comprise at least one mention of the product.
